(19) United States
(12) Patent Application Publication
(10) Pub. No.: US 2009/0016304 A1
(43) Pub. Date: Jan. 15, 2009

(54) Method for Control of a Connection Exchange Between Network Access Devices

(75) Inventors: Stefan Aust, Kyoto (JP); Reinhard Gloger, Kaufering (DE); Carmelita Gorg, Bremen (DE); Cornel Pampu, Berlin (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munchen (DE)

(21) Appl. No.: 11/791,037

(22) PCT Filed: Nov. 4, 2005
(86) PCT No.: PCT/EP05/55741

§ 371 Date: May 2, 2008

(30) Foreign Application Priority Data
Nov. 18, 2004 (DE) 10 2004 055 720.9

(51) Int. Cl. H04Q 7/00

(52) U.S. Cl. 370/332

(57) ABSTRACT

A method in a user terminal controls f a connection exchange between network access devices in a connection layer, whereby at least one quality parameter is determined on the basis of signal transmissions of a current provider network access device on a physical layer. Depending on the at least one determined quality parameter, at least one request is transmitted to the first network access device and/or to at least one second network access device and, dependent on receipt of at least one message from the first and/or the at least one second network access device, a connection exchange to the second network access device is initiated.

### CROSS REFERENCE TO RELATED APPLICATIONS

This application is based on and hereby claims priority to PCT Application No. PCT/EP2005/0055741 filed on Nov. 4, 2005 and German Application No. 10/2004 055 720.9 on Nov. 18, 2004, the contents of which are hereby incorporated by reference.

### BACKGROUND

The invention relates to a method for controlling a connection transfer between network-access devices, in particular between two radio-communication systems. The invention relates further to a user terminal that implements the method.

In radio-communication systems, for example the European second-generation GSM (Global System for Mobile communications) mobile-radio system, information (for example voice, image information, or other data) is transmitted over a radio interface with the aid of electromagnetic waves. The radio interface relates to a connection between a base station and user terminals, which can be mobile stations or stationary radio stations. The electromagnetic waves are therein emitted using carrier frequencies lying within a frequency band provided for the respective system. Developments based on the GSM system, known by the terms GPRS or EDGE, for transmitting faster data rates are referred to as belonging to generation 2.5. Compared to the second generation, radio-communication systems such as, for example, UMTS (Universal Mobile Telecommunication System) or other third-generation systems are designed for even faster data rates. Two modes are provided for third-generation mobile radio, one being an FDD (Frequency Division Duplex) mode and the other a TDD (Time Division Duplex) mode. Said modes are employed in different frequency bands and each support what is termed a CDMA (Code Division Multiple Access) user-separation method.

Through a combination of known WLAN (Wireless Local Area Network) infrastructures and above-described cellular mobile-radio systems, users of mobile terminals are allowed to change over active connections between said wireless access systems. That is supported by mobility protocols such as, for example, what is termed Mobile IPv4 (Internet Protocol version 4) and Mobile IPv6 (Internet Protocol version 6). The Mobile Internet Protocol (MIP) therein allows a mobile terminal to be able to retain an assigned IP address on changeover from one to another wireless system and thus to be directly addressable via said IP address regardless of the system via which it is presently connected. Said protocol is described inter alia in detail in C. E. Perkins “IP Mobility Support”, Request for Comments (Proposed Standard) 2002, Internet Engineering Task Force (IETF), Oct. 1996.

Basic approaches to the forwarding of connections between in this manner heterogeneous systems are described in S. Aust, D. Proetel, A. Konsgen, C. Pampu, C. Gorg “Design Issues of Mobile IP Handoffs between General Packet Radio Service (GPRS) Networks and Wireless LAN (WLAN) System”, WPMC 2002, Honolulu, Hawaii (USA), October 2002. Discussed in particular therein is the problem, due to undefined transfers, of the disadvantageous possible loss of data and breaks in connection during a connection transfer between WLAN systems and cellular mobile-radio systems. Loss of data and breaks in connection of said type are ascribable in particular to situations in which the mobile user terminal is located in an edge region of WLAN coverage and could perform a transfer to a cellular system. What is termed a ping-pong effect, wherein a connection is transferred repeatedly between the two access systems owing to, for example, undefined or inadequately defined thresholds, can, though, in that case occur during the connection transfer controlled by the Mobile IP protocol. Said ping-pong effect is therein a result, for instance, of the fact that what are termed mobile agent advertisements, which support mobility detection of the mobile terminal, can owing to the deteriorating transmission conditions be received only sporadically or irregularly by a mobile user terminal in the edge region of WLAN coverage.

In the internet draft by S. Aust, N. A. Fikouras, C. Görg, C. Pampu “Policy Based Mobile IPv6 Handover Decision (POLIMAND)”, Feb. 15, 2004, published inter alia under the internet address http://www.comnets.uni-bremen.de/˜aust/draft-iponair-dna-polimand-0.1.txt, for resolving the problem of the ping-pong effect it is proposed for a mobile user terminal to perform a connection transfer when the reception of advertisements from the presently provisioning system is disrupted owing to, for example, deteriorating transmission conditions on the radio interface to the presently provisioning network-access device. That is done by in a qualified manner suppressing forwarding of the advertisements received on the Physical Layer (Layer 1) to the superordinate Network Layer (Data Link Layer, Layer 2) based on, for example, measurements of the Physical Layer in terms of a transmission quality of the present connection. Because the Network Layer controlling the mobile user terminal's mobility will as a result of said suppressing cease receiving advertisements, it will immediately initiate a connection transfer to an alternative network-access device.

Mechanisms of the Internet Protocol version 6 (IPv6) that support a disruption and loss-free mobility of mobile user terminals have been presented and defined in various publications. For example a simplified protocol structure for optimizing mobile IP services is known from S. Deering, R. Hinden “Internet Protocol, Version 6 (IPv6) Specification”, December 1998, RFC2460, RFC.net. Included among these are, for example, the exchange of what are termed binding updates to correspondent nodes and what is termed Neighbor Discovery, for obtaining information about neighbors, as is known from T. Narten, E. Nordmark, W. Simpson “Neighbor Discovery for IP Version 6 (IPv6)”, December 1998, RFC2461, RFC.net. An automatic IP Address Autoconfiguration is furthermore described in S. Thomson, T. Narten “IPv6 Stateless Address Autoconfiguration” December 1998, RFC2462, RFC.net. An overview of the introduction of Mobile IPv6 in aforementioned 2G and 3G systems is provided by the White Paper “Introducing Mobile IPv6 in 2G and 3G mobile networks”, Nokia, December 2001, published at http://nds2.ir.nokia.com/downloads/aboutnokia/press/pdf/whitepaper mipv6 1s.pdf.

The methods contained in the IPv6 protocol are, though, generally unsuitable for supporting a high mobility of mobile terminals, which is to say, for example, a fast speed and consequent frequent changing of the provisioning radio cell or, as the case may be, provisioning system. That is because of, for example, what is termed Neighbor Unreachability Detection as a function of the aforementioned Neighbor Discovery. Neighbor Unreachability Detection is based on a positive acknowledgement of the receipt of what are termed solicitation messages sent by a mobile terminal to specific neighboring nodes in order to ascertain a possible loss of the path to the respective neighboring node. However, the algorithms defined for said detection result in the old routing entries' not being deleted, thereby preventing or, as the case may be, delaying fast transfer to another access network. The Address Autoconfiguration, for example, furthermore requires information about the new access network in order then to apply what is termed a Duplicate Address Detection algorithm resulting in a unique address configuration. However, said algorithm requires a relatively lengthy period of time during which the mobile terminal may already cease being provisioned by the previous access network and not yet be able to be provisioned by the new access network. Owing to the delays due thereto, a loss of data packets can disadvantageously occur during transmission to/from the mobile terminal.

### SUMMARY

One possible object of the invention is thus to disclose a method and a user terminal by both of which a connection transfer between two systems can be accelerated.

The inventors propose a request in keeping with, for example, the known router solicitations or, as the case may be, neighbor solicitations is sent by a user terminal based on at least one determined quality parameter to the presently provisioning network-access device and/or to at least one second network-access device to which a transfer could take place. As a function of relevant messages, for example the known advertisements sent in response to the solicitations, the user terminal initiates a connection transfer to a second network-access device.

The method advantageously facilitates a user terminal's early recognition, based on determining the at least one quality parameter, of a connection transfer requiring to be carried out in order on the basis of said recognition to employ suitable mechanisms for setting up a connection to a new system. Owing to the setting up of a connection to the new network-access device and the simultaneously still existing connection to the presently provisioning network-access device, what is ideally a seamless connection transfer can take place with a consequent significantly reduced risk of data loss on the connection. Compared to the algorithms that were described in the foregoing and are to be characterized as purely reactive, being of a kind that launch methods for setting up a new connection to another network-access device based solely on the information that a presently provisioning network-access device is no longer reachable, the method will already proactively perform steps for setting up a new connection when the present connection has not yet been broken although there are indications of a future break.

Said proactively performed steps therein include in particular accelerated reconfiguring of an access address of the network-access device via which the connection is subsequently to be conducted instead of the presently provisioning network-access device. Said accelerated reconfiguring can be achieved by various alternative or complementary methods.

According to one exemplary embodiment, requests in the form of what are termed router solicitations and/or neighbor solicitations are sent from the user terminal to the network-access devices. The sending of router solicitations therein causes the present network-access device, as a supplement to the periodic sending of advertisements, to in each case send back to the user terminal an advertisement indicating an availability of the network-access device to the receiving user terminal. Advertisements of said type contain, for example, information about various connection and internet parameters as well as for address configuring. The user terminal can after receiving one or more advertisements of said type in turn determine one or more quality parameters on the basis of which procedures for a connection transfer will or will not be initiated.

The sending of neighbor solicitations, by contrast, serves for example to determine Link Layer addresses of neighboring network-access devices receiving said solicitations or, as the case may be, to check whether the addresses reported back in response to previous requests or, as the case may be, the associated network-access devices will continue being reachable by the user terminal. The network-access devices receiving said type of requests respond thereto with what are termed neighbor advertisements. Through receiving and evaluating neighbor advertisements from one or more neighboring network-access devices it is thus possible for new network-access devices, and ones that are suitable for transferring the connection, to be determined by the user terminal. That is done advantageously already while a connection still exists to a presently provisioning network-access device and not, as in the related art, only after the connection has been broken. The information contained in advertisements is employed in the user terminal for reconfiguring the access address.

The aforementioned solicitations and advertisements are generally called Internet Control Message Protocol (ICMP) packet types.

According to a further exemplary embodiment the user terminal checks possible connections to neighboring network-access devices in order to select one that is suitable for continuing the connection. For example what is termed Neighbor Unreachability Detection (NUD) is used by the user terminal for that purpose. Said Neighbor Unreachability Detection is a major criterion for, within the context, influencing the access data's configuration as early as possible. Apart from checking the presently existing connection it is also possible within the scope of the NUD to check and update a current routing table.

Alongside further functions, Neighbor Unreachability Detection thus serves to determine whether a neighboring network-access device will or will not continue being reachable. Following on from what is termed an address resolution, which is to say respective determining of the Link Layer address of neighboring network-access devices, the user terminal sends requests in the form of neighbor solicitations using respective addressing, which is to say according to what is termed a unicast, to the neighboring network-access devices that have been determined. The network-access devices that are addressed and receive the requests in turn send neighbor advertisements back to the user terminal.

If an addressed network-access device does not send back a neighbor advertisement or, as the case may be, the user terminal ceases receiving said message, which can occur owing, for example, to said network-access device's provisioning range having been left, then the corresponding network-access device or, as the case may be, its address will be removed from the routing table in the user terminal and subsequently no longer be taken into account for a possible connection transfer. By sending above-described neighbor solicitations and receiving corresponding neighbor advertisements, the user terminal can as a countermove include an alternative neighboring network-access device in the routing table and, as described in the foregoing, periodically or, for example, under the control of changes in the connection to the presently provisioning network-access device check the connection quality thereto.

According to a further exemplary embodiment of the method it is possible, for example according to the Policy Based Mobile IPv6 Handover Decision (POLIMAND) mechanism mentioned in the introduction, to suppress forwarding of messages, for example advertisements, to a superordinate Network Layer as a function of determined quality parameters during the reception of messages from the presently provisioning and/or neighboring network-access devices. As a supplement to said mechanism it is possible to suppress or forward not only the messages sent periodically from the presently provisioning network-access device but also, based on the same criteria, messages received based on explicit requests, for example solicitations, from the presently provisioning and/or neighboring network-access devices.

Thus if although having been received by the user terminal a message fails to meet the requirements placed on transmission quality, then the forwarding of said message to superordinate layers will be suppressed and, as a consequence thereof, the connection declared invalid in the superordinate layers, for example the Network Layer in which the Mobile IP is implemented, and accordingly removed from the routing table.

What is advantageously achieved thereby is that only addresses of alternative network-access devices to which a connection transfer seems possible in terms at least of meeting predefined quality parameters will be kept in the routing table.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows exemplary Mobile IP-based connection transfers between different access networks;

FIG. 2 shows a layer model with an exemplary integration of POLIMAND; and

FIG. 3 shows a controlling of the suppression of messages by POLIMAND.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

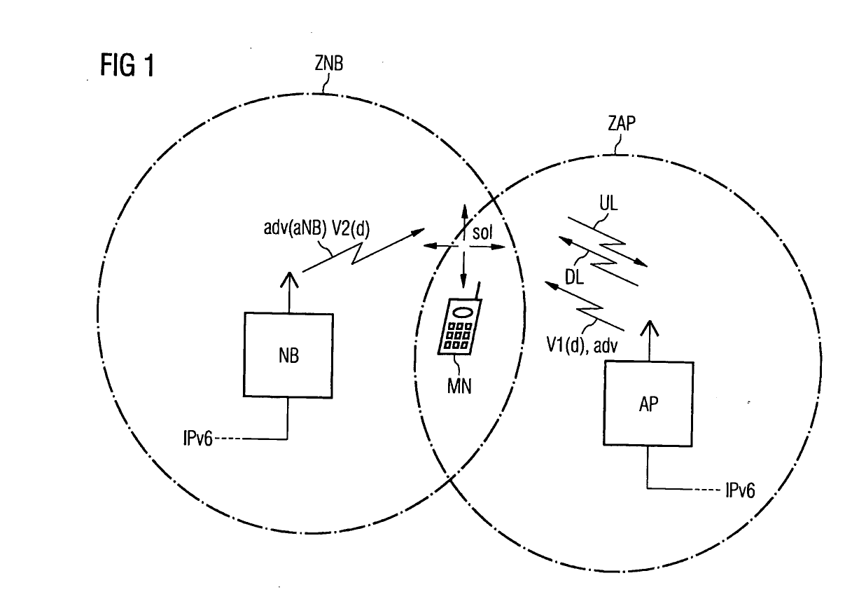

FIG. 1 shows by way of example a situation of a connection transfer between two radio-communication systems, for example between respective network-access devices of what is termed a WLAN system and of a cellular mobile-radio system, but without being restricted thereto. In the example shown in FIG. 1 a user terminal MN (mobile node) is located in a radio cell ZAP of what is termed an access point AP of the WLAN system and is supplied by the access point AP in an existing first connection V1 with data d of what is termed a correspondent node (CN) as the data source. The user terminal MN can accordingly send the first connection V1 for transmitting data to the correspondent node via the access point AP, with said transmission direction not being shown. Independently of the transmission of data d, at periodic intervals the access point AP sends what are termed advertisements adv that indicate to the user terminal MN a presence of the access point AP, and also signal further connection and internet parameters to the user terminal MN. The access point AP may be connected to the internet via further components (not shown) of the WLAN system. The Internet Protocol version 6 IPv6 is employed as the protocol. Transmissions to/from the user terminal MN are indicated by arrows, with transmissions to the user terminal MN being designated downlink DL transmissions and those from the user terminal MN uplink UL transmissions.

The user terminal MN is further located in, for example, a radio cell ZNB of a base station NB (node B) of a cellular mobile-radio system, for example a UMTS system. Let it, owing to a movement performed by the user, be assumed that the user terminal MN moves out of the provisioning range of the access point AP and towards the radio cell ZNB of the base station NB, which is likewise connected to the internet via possible further components of the mobile-radio system.

By mechanisms described in more detail below, procedures for preparing for a transfer of the active first connection V1 to an alternative network-access device are performed in the user terminal MN though without already releasing the existing first connection V1. Neighbor solicitations sol are for that purpose first sent within the scope of what is termed the Neighbor Discovery of the IPv6 by the user terminal MN in order to obtain information about neighboring network-access devices and ones that are suitable for a connection transfer. Neighbor Discovery can additionally thereto be carried out for example periodically by the user terminal MN in order, with a connection existing, to continuously register possible alternative network-access devices or, for the purpose of setting up a connection, to select a suitable network-access device. As a supplement to neighbor solicitations sol, router solicitations can also be sent by the user terminal MN to the presently provisioning access point AP in order as a supplement to its periodic sending of advertisements to check and assess a current reachability.

It is further assumed in the example shown in FIG. 1 that the base station NB receives the neighbor solicitations sol of the user terminal MN and establishes the possibility of provisioning the user terminal MN. In that case the base station NB will send back at least one neighbor advertisement adv to the user terminal MN including information about an address aNB, for example a Link Layer address.

Said address information received from the base station NB will, provided quality parameters determined from the advertisement meet predefined conditions, be entered by the user terminal MN in what is termed a routing table. The address information will then be used by the user terminal MN within the scope of Neighbor Unreachability Detection in order by solicitations addressed directly to the base station NB to request advertisements therefrom. The user terminal MN performs corresponding steps with further network-access devices likewise suitable for a connection transfer that respond to neighbor solicitations sent by the user terminal MN with an advertisement.

The registering of neighboring network-access devices' address information and the checking thereof serve to in a timely manner reconfigure the access address, for example the network-access device's IPv6 address, via which data d can after a second connection V2 has been set up be transmitted almost immediately after the first connection V1 to the previously provisioning network-access device has been released. In the example shown in FIG. 1 the user terminal MN would, after it has been established that the base station NB is suitable for transferring the first connection V1 and that there is a risk that the first connection V1 to the access point AP will be broken owing to deteriorating transmission conditions on the radio interface, reconfigure the access address of the base station NB as that to be used for a new second connection V2 and will use said address when the first connection V1 to the access point AP has been released. Contrary to the related art described in the introduction, time-consuming reconfiguring of the access address thus takes place while the first connection V1 to the presently provisioning network-access device is still established. An interruption in data transmission will advantageously be shortened thereby or even a seamless connection transfer achieved if the existing connection is not released until after the address has finished being reconfigured. The instant at which the connection is transferred can therein advantageously be selected independently of, for example, the iPv6 protocol. A high mobility of the user terminal MN, associated with a relatively frequent need for a connection transfer, can in particular also advantageously be supported thanks to the relatively early reconfiguring of the access address.

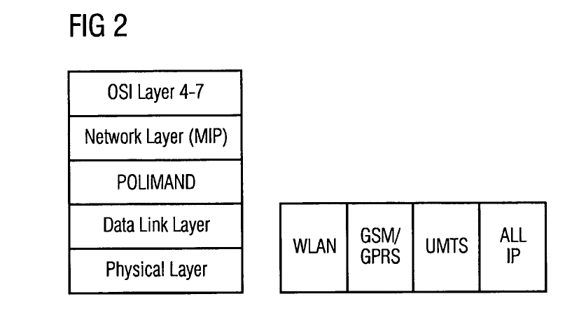

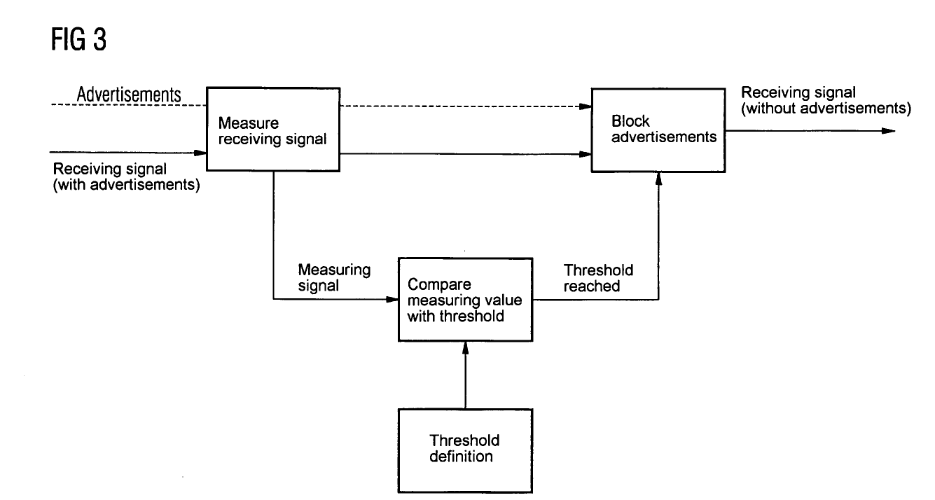

An implementation of the POLIMAND-based method in a user terminal is described below with reference to FIGS. 2 and 3.

FIG. 2 shows by way of example a known OSI layer model as employed in telecommunications engineering for defining different layers. A transmission of signals over a transmission medium, by which, for example, the radio interface is to be understood, takes place at the lowest layer, what is termed the Physical Layer, also called Layer 1. The Physical Layer's structure is dependent on the respectively employed radio standard defined according to, for example, the cited WLAN or, as the case may be, 802.11, GSM/GPRS, UMTS standards etc.

The connection is controlled at a superordinate layer, what is termed the Data Link Layer. Said controlling also includes analyzing or, as the case may be, determining current transmission characteristics or, as the case may be, quality parameters of the Physical Layer in order to match connection parameters in keeping with said current transmission characteristics. Transmission characteristics can be determined in the form of, for instance, a signal-to-noise ratio (SNR), a signal strength, a noise power, a bandwidth, a latency, or a bit error rate or frame error rate or, as the case may be, further quality-of-service (QoS) parameters of the received signal.

Proceeding from the example shown in FIG. 1, the known “quality link”, “quality level”, and/or “noise level” parameters can in the case of a WLAN system be used for assessing the current transmission parameters, with the “quality link” parameter being a combination of the other two parameters and hence containing information about a current signal strength and noise power.

The use of uniform parameters is advantageous particularly in view of an application in different systems. That can be done also in the form of a combination of a plurality of aforementioned parameters for defining an optimal decision criterion for controlling a connection transfer. That applies in particular to future what are termed Generic Link Layer (GLL) standards in which uniform network parameters will be used for different access systems.

To allow a connection transfer between network-access devices that support different transmission standards it is expedient to select a quality parameter that can be determined in the supported networks, for example networks based on the cited WLAN, GSM/GPRS, or UMTS standards or purely IP-based All IP. A carrier-to-interference/signal-to-noise ratio is used in the example described below as a quality parameter of said type.

Above the Data Link Layer is an intermediate layer called POLIMAND (Policy based Mobile IP Handoff Decision). As will be explained in more detail below, as a function of quality parameters determined on the Data Link Layer said intermediate layer decides in keeping with what was described above whether messages received on the Physical Layer will or will not be forwarded to a Network Layer.

The connection transfer is controlled again at the Network Layer, referred to also a Layer 3, based on the Mobile Internet Protocol MIP according to known mechanisms. Further embodiments of the standard, for example what is termed the Hierarchical Mobile IP (HMIP) or what is termed the Fast Hierarchical Mobile IP (FHMIP), can be similarly employed as an alternative to the cited Mobile IP. Above the Network Layer are further layers corresponding to the OSI layer model, although these will not be considered further in terms of their content.

Shown by way of example in FIG. 3 is a flowchart of the POLIMAND intermediate layer's mode of functioning in conjunction with the layers described above and below it in an implementation in a user terminal MNN in the situation described that is shown in FIG. 1.

The user terminal MN receives signals, sent over the radio interface, from an access point AP and signals from a neighboring base station NB, with the receiving signals also containing messages, for example advertisements. The signal flow of the advertisements is shown by a dashed line. From a measurement performed on the receiving signal, a measuring signal is determined as an input variable for an ensuing comparison with a threshold. As previously described, the measuring signal constitutes by way of example a carrier-to-interference/signal-to-noise ratio as a quality parameter providing information about the current signal quality. If the signal quality deteriorates, then a connection transfer will be necessary from a present provisioning access point AP to an alternative network-access device. If, though, the receiving signal exhibits sufficient signal quality, then a connection transfer will not be necessary at this stage.

The determined quality parameter in the form of a measuring signal is compared with a threshold. The threshold is therein defined, for example, as a function of the respective transmission standard in order to take account of individual differences in the various transmission methods. The thresholds can, for example, be defined by the respectively presently provisioning system and transmitted to the user terminal after or during a connection setup and stored in the user terminal.

The quality parameter is in the example shown compared with a defined threshold constituting a lower value of a carrier-to-interference/signal-to-noise ratio that suffices for a connection. When said threshold is reached or undershot, a connection transfer should in accordance with the foregoing description take place to a network-access device having more favorable transmission characteristics.

Alongside a lower threshold for a connection transfer to another network-access device, for example a base station NB, an upper threshold has furthermore been defined on the reaching or undershooting of which a connection transfer would take place from the other system back to the original system. By said two thresholds a hysteresis is defined that will avoid the above-described ping-pong effect and, for example, additionally insure that a connection will be conducted for as long a period as possible over the WLAN access point because that can make a significantly higher transmission capacity available than, for example, the base station NB.

If the determined quality parameter reaches or undershoots the defined threshold during the comparison, then forwarding of the received advertisements to the Network Layer or, as the case may be, Mobile IP MIP will then be suppressed or, as the case may be, blocked. Only the further receiving signals will accordingly be transferred without any messages to the superordinate layer (the dashed line terminates there). Said suppressing or, as the case may be, blocking can be implemented by, for example, a system script. An analogous procedure would be realized were the upper threshold exceeded.

Through the suppressing or, as the case may be, blocking of advertisements it is already suggested at an earlier instant to the Mobile IP mechanisms responsible for mobility and for the connection transfer that the transmission characteristics have deteriorated and hence that a connection transfer to a further system is necessary. The aim of a more defined and accelerated connection transfer is achieved thereby, as a result of which a loss of data packets due to connection transfers will advantageously be minimized. It further serves advantageously to enable advertisements sent at the user terminal's request by alternative network-access devices to be suppressed and hence the inclusion of said devices in the user terminal's routing table to be prevented if the transmission characteristics are insufficient for a connection transfer.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-9. (canceled)

10. A method for controlling a connection transfer between first and second network-access devices that are assigned to an identical radio-communication system or to different radio-communication systems, comprising:
determining a quality parameter in a Link Layer based on signal transmissions in a presently provisioned connection between a user terminal and the first network-access device on a Physical Layer, the quality parameter being determined at the user terminal;
sending a request to the first network-access device and/or the second network-access device as a function of the quality parameter;
transmitting an advertisement message from the first and/or the second network-access device; and
initiating a connection transfer from the first network-access device to the second network-access device as a function of receiving the advertisement message .

11. The method as claimed in claim 10 wherein
mobility-controlling mechanisms of a Network Layer are used for deciding whether to initiate the connection transfer,
advertisement messages from the presently provisioned first network-access device are selectively forwarded from the Physical Layer to the Network Layer, and
forwarding the advertisement messages from the presently provisioned first network-access device is carried out or suppressed as a function of the quality parameter.

12. The method as claimed in claim 10 wherein
a decision about forwarding advertisement messages from the first and/or second network-access device is made in an intermediate layer located between the Link Layer and the mobility-controlling Network Layer.

13. The method as claimed in claim 10 wherein
the user terminal receives from the second network-access device an advertisement message containing information about an address of the second network-access device, and
the user terminal enters the address information in a routing table.

14. The method as claimed claim 13 wherein
after the user terminal sends the request, the user terminal sends a device-specific request to a designated network-access device, and
the user terminal uses the address information of the second network-access device for device-specific request.

15. The method as claimed in claim 13 wherein
the user terminal uses the address information for setting up a connection to the second network-access device .

16. The method as claimed in claim 10 wherein
the connection transfer takes place between network-access devices supporting different standards on the Physical Layer.

17. The method as claimed in claim 11 wherein
a decision about forwarding advertisement messages from the first and/or second network-access device is made in an intermediate layer located between the Link Layer and the mobility-controlling Network Layer.

18. The method as claimed in claim 17 wherein
the user terminal receives from the second network-access device an advertisement message containing information about an address of the second network-access device, and
the user terminal enters the address information in a routing table.

19. The method as claimed claim 18 wherein
after the user terminal sends the request, the user terminal sends a device-specific request to a designated network-access device, and
the user terminal uses the address information of the second network-access device for device-specific request.

20. The method as claimed in claim 19 wherein the user terminal uses the address information for setting up a connection to the second network-access device .

21. The method as claimed in claim 20 wherein the connection transfer takes place between network-access devices supporting different standards on the Physical Layer.

22. A user terminal comprising:
a receiver to receive signals transmitted on a Physical Layer from a first network-access device in a first connection;
a determination unit to determine a quality parameter based on the signals received a transmitter to send a request to the first network-access device and/or a second network-access device as a function of the quality parameter; and
an initiating unit to initiate a connection transfer to the second network-access device as a function of receiving an advertisement message from the first and/or second network-access device.

23. The user terminal (MN) as claimed in claim 22 further comprising:
a controller to selectively forward advertisement messages received from the first network-access device to mobility-controlling mechanisms of a Network Layer as a function of the quality parameter, the mobility-controlling mechanisms controlling the connection transfer to the second network-access device.
